(19) United States
(12) Patent Application Publication
(10) Pub. No.: US 2012/0270146 A1
(43) Pub. Date: Oct. 25, 2012

(54) MAGNETIC TONER COMPOSITIONS

(75) Inventors: Ke Zhou, Oakville (CA); Suxia Yang, Mississauga (CA); Cuong Vong, Hamilton (CA); Paul J. Gerroir, Oakville (CA); Karen Ann Moffat, Brantford (CA); Gabriel Iftime, Mississauga (CA)

(73) Assignee: XEROX CORPORATION, Norwalk, CT (US)

(21) Appl. No.: 13/090,521

(22) Filed: Apr. 20, 2011

(51) Int. Cl. G03G 9/083; B82Y 99/00

(52) U.S. Cl. 430/106.1; 430/137.14; 977/773

(57) ABSTRACT

The present disclosure relates to a process for preparing a polyester-based magnetic toner composition. The toner composition includes one or more polyester amorphous binder resins, optionally a crystalline polyester resin, and spherical barium iron oxide particles. In embodiments, the toner is prepared from barium iron oxide particles that are in a dispersion including water and a dispersant. In yet other embodiments, the process may be conducted under an inert gas such as argon to avoid oxidation of the ferromagnetic particles during toner preparation.

### TECHNICAL FIELD

The present disclosure relates to polyester resin based toners, including magnetic toners, and methods for producing the same.

### BACKGROUND

Toners containing crystalline or semi-crystalline polyester resins with at least one amorphous resin have recently been shown to provide very desirable ultra low melt temperature fusing, which is important for both high-speed printing and lower fuser power consumption. These types of toners containing amorphous and crystalline polyesters have been used for both emulsion aggregation (EA) toners, and in conventional jetted toners. Combinations of amorphous and crystalline polyesters may provide toners with relatively low-melting point characteristics (sometimes referred to as low-melt, ultra low melt, or ULM), which allows for more energy-efficient and faster printing.

Emulsion aggregation coalescing processes for the preparation of toners are illustrated in a number of patents, such as U.S. Pat. Nos. 5,290,654, 5,278,020, 5,308,734, 5,344,738, 6,416,920, 6,576,389, 6,593,049, 6,743,559, 6,756,176, 6,830,860, 7,029,817, and 7,329,476, and U.S. Patent Application Publication Nos. 2006/0216626, 2008/0107990, 2008/0107989, 2008/0236446, and 2009/0047593. The disclosures of each of the foregoing patents and published patent applications are hereby incorporated by reference in their entirety.

Magnetic printing methods employ inks or toners containing magnetic particles. Various magnetic inks and toners have been used in printing digits, characters, or artistic designs, on checks, bank notes and/or currency. The magnetic inks used for these processes may contain, for example, magnetic particles, such as magnetite in a fluid medium, and/or a magnetic coating of ferric oxide, chromium dioxide, or similar materials dispersed in a vehicle including binders and plasticizers.

Toners for Magnetic Ink Character Recognition (“MICR”) applications require a minimum magnetic remanence (e.g., magnetization retained by a magnetized object when an external magnetic field is removed) and retentivity (e.g., remanence as measured in units of magnetic flux density, electromagnetic units per gram) to enable check reader/sorters to read the magnetically encoded text. Remanence is synonymous with retentivity and is a measure of the magnetism remaining when the magnetic particle is removed from the magnetic field, i.e., the residual magnetism. When characters printed using an ink or toner having a sufficiently high retentivity are read, the magnetic particles produce a measurable signal that can vary in proportion to the amount of material deposited on the document being generated.

Thus, a magnetic material may be added to the toner. Magnetite (iron oxide) is often used, with an acicular crystal shape. For example, U.S. Pat. Nos. 6,617,092 and 7,282,314, the entire disclosures of each of which are incorporated by reference herein, describe the use of these magnetites in the formation of MICR toners. Acicular magnetites are often 0.1×0.6 microns along the minor and major axis in size. Due to the large size of the long dimension of these particles, along with the high density of the magnetite, these particles are difficult to disperse and stabilize, and also difficult to incorporate into toner, especially in an emulsion/aggregation toner process. Thus, high levels of these magnetites may be required, which may cause difficulties in the aggregation and coalescence of an EA toner.

Conventional ferromagnetic particles, such as iron oxide particles, have an acicular (e.g., needle-shaped) crystal shape and a high density, making it difficult to form dispersions from these particles. This also inhibits incorporation of the particles into toners, especially in EA toner processes. Furthermore, to achieve minimum magnetic remanence and coercivity (e.g., intensity of the applied magnetic field) required by the toners, very high loadings of iron oxide may be required due to its relatively low retentivity.

It would be advantageous to provide magnetic materials for forming magnetic inks and toners that provide a number of advantages, including, for example, advantageous processing of the materials.

### SUMMARY

The present disclosure provides magnetic toner compositions and methods for making same. In embodiments, a toner of the present disclosure may be an emulsion aggregation toner including at least one resin in combination with one or more optional ingredients such as colorants, waxes, and combinations thereof; and a plurality of magnetic metal oxide nanoparticles, wherein the magnetic metal oxide is of the formula MₓN_{y}O_{z}, wherein M is Mn, Co, Ni, Mg, Cu, Zn, Ba, Sr, and combinations thereof, N is Fe, Co, Ni, and combinations thereof, x is from 0.1 to 20, y is from 1 to 20, and z is from 1 to 40.

A process of the present disclosure may include, in embodiments, contacting at least one resin emulsion and a plurality of magnetic metal oxide nanoparticles in a mixture; aggregating the mixture at a pH from about 1 to about 6 to form particles; adjusting the pH of the mixture to from about 6 to about 14 to stop growth of the particles; coalescing the particles at a pH from about 3 to about 9 to form toner particles; and recovering the toner particles, wherein the magnetic metal oxide is of the formula MₓN_{y}O_{z}, wherein M is Mn, Co, Ni, Mg, Cu, Zn, Ba, Sr, and combinations thereof, N is Fe, Co, Ni, and combinations thereof, x is from 0.1 to 20, y is from 1 to 20, and z is from 1 to 40.

In other embodiments, a process of the present disclosure may include contacting at least one resin emulsion and a plurality of magnetic metal oxide nanoparticles in a mixture; aggregating the mixture at a pH from about 1 to about 6 to form particles; adjusting the pH of the mixture to from about 6 to about 14 to stop growth of the particles; coalescing the particles at a pH from about 3 to about 9 to form toner particles; and recovering the toner particles, wherein the magnetic metal oxide is of the formula MₓN_{y}O_{z}, wherein M is Mn Co, Ni, Mg Cu, Zn, Ba, Sr, and combinations thereof, N is Fe, Co, Ni, and combinations thereof, x is from 0.1 to 20, y is from 1 to 20, and z is from 1 to 40, and wherein the plurality of magnetic metal oxide nanoparticles possess a circularity of from about 0.65 to about 1.

In some embodiments, the plurality of magnetic metal oxide particles may be in a dispersion with a dispersant and water.

### DETAILED DESCRIPTION

The present disclosure provides an EA MICR toner composition, including one or more binder resins and magnetic metal oxide nanoparticles, in specific embodiments barium iron oxide (BaFe₁₂O₁₉) nanoparticles. Barium iron oxide has magnetization saturation (i.e., the maximum amount of magnetization, which won't increase as the magnetic field increases) of about 29.18 electromagnetic units per gram (emu/g) and retentivity of about 18.15 emu/g, whereas iron oxide has magnetization saturation of about 66 emu/g and retentivity of about 5.3 emu/g. Thus, the retentivity of barium iron oxide is approximately more than three times that of iron oxide. This allows for toners incorporating barium iron oxide as the magnetic material to achieve the same remanence and coercivity with a particle loading that is about one third the amount needed for iron oxide particles.

Also provided is a process for preparing these EA MICR toners containing magnetic metal oxide nanoparticles, in embodiments, barium iron oxide nanoparticles. In embodiments, a magnetic metal oxide nanoparticle dispersion is contacted with other toner components under homogenization, and aggregation of the toner is conducted at a pH from about 2 to about 5 a, with the use of a flocculent or aggregating agent. Additionally, in embodiments, freezing (stopping particle growth) may be accomplished by adjusting the pH to from about 7 to about 12 and coalescence of the toner particles may be conducted at a pH from about 3 to about 9. In embodiments, a dispersion including the barium iron oxide particles herein becomes readily incorporated into the toner formulation without affecting particle morphology.

### Resins

Toners of the present disclosure may include any latex resin suitable for use in forming a polyester toner. Such resins, in turn, may be made of any suitable monomer. In embodiments, the polymer utilized to form the resin may be a polyester resin. Suitable polyester resins include, for example, sulfonated, non-sulfonated, crystalline, amorphous, combinations thereof, and the like. The polyester resins may be linear, branched, combinations thereof, and the like. Polyester resins may include, in embodiments, those resins described in U.S. Pat. Nos. 6,593,049 and 6,756,176, the disclosures of each of which are hereby incorporated by reference in their entirety. Suitable resins may also include a mixture of an amorphous polyester resin or resins and a crystalline polyester resin as described in U.S. Pat. No. 6,830,860, the disclosure of which is hereby incorporated by reference in its entirety.

In embodiments, a resin utilized in forming a toner may include an amorphous polyester resin. In embodiments, the resin may be a polyester resin formed by reacting a diol with a diacid or diester in the presence of an optional catalyst.

Examples of organic diols selected for the preparation of amorphous resins include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol is, for example, selected in an amount of from about 45 to about 50 mole percent of the resin, and the alkali sulfo-aliphatic diol can be selected in an amount of from about 1 to about 10 mole percent of the resin.

Examples of diacid or diesters selected for the preparation of the amorphous polyester include dicarboxylic acids or diesters selected from the group consisting of terephthalic acid, phthalic acid, isophthalic acid, fumaric acid, maleic acid, itaconic acid, succinic acid, succinic anhydride, dodecylsuccinic acid, dodecylsuccinic anhydride, dodecenylsuccinic acid, dodecenylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, dimethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, dimethyl dodecenylsuccinate, and mixtures thereof. The organic diacid or diester is selected, for example, from about 45 to about 52 mole percent of the resin.

Examples of suitable polycondensation catalyst for either the amorphous polyester resin include tetraalkyl titanates, dialkyltin oxide such as dibutyltin oxide, tetraalkyltin such as dibutyltin dilaurate, dialkyltin oxide hydroxide such as butyltin oxide hydroxide, aluminum alkoxides, alkyl zinc, dialkyl zinc, zinc oxide, stannous oxide, or mixtures thereof; and which catalysts are selected in amounts of, for example, from about 0.01 mole percent to about 5 mole percent based on the starting diacid or diester used to generate the polyester resin.

In embodiments, suitable amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), a copoly(propoxylated bisphenol A co-fumarate)-copoly(propoxylated bisphenol A co-terephthalate), a terpoly(propoxylated bisphenol A co-fumarate)-terpoly(propoxylated bisphenol A co-terephthalate)-terpoly-(propoxylated bisphenol A co-dodecylsuccinate), and combinations thereof. In embodiments, the amorphous resin utilized in the core may be linear or branched.

In embodiments, a suitable amorphous resin may include alkoxylated bisphenol A fumarate/terephthalate based polyesters and copolyester resins. In embodiments, a suitable amorphous polyester resin may be a copoly(propoxylated bisphenol A co-fumarate)-copoly(propoxylated bisphenol A co-terephthalate) resin having the following formula (I):

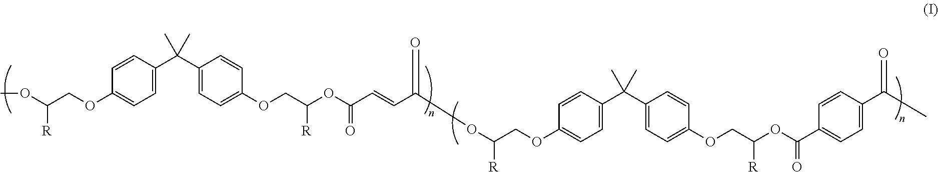

wherein R may be hydrogen or a methyl group, and m and n represent random units of the copolymer and m may be from about 2 to 10, and n may be from about 2 to 10.

An example of a linear copoly(propoxylated bisphenol A co-fumarate)-copoly(propoxylated bisphenol A co-terephthalate) which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, North Carolina and the like.

In embodiments, the amorphous polyester resin may be a saturated or unsaturated amorphous polyester resin. Illustrative examples of saturated and unsaturated amorphous polyester resins selected for the process and particles of the present disclosure include any of the various amorphous polyesters, such as polyethylene-terephthalate, polypropylene-terephthalate, polybutylene-terephthalate, polypentylene-terephthalate, polyhexylene-terephthalate, polyheptadene-terephthalate, polyoctalene-terephthalate, polyethylene-isophthalate, polypropylene-isophthalate, polybutylene-isophthalate, polypentylene-isophthalate, polyhexylene-isophthalate, polyheptadene-isophthalate, polyoctalene-isophthalate, polyethylene-sebacate, polypropylene sebacate, polybutylene-sebacate, polyethylene-adipate, polypropylene-adipate, polybutylene-adipate, polypentylene-adipate, polyhexylene-adipate, polyheptadene-adipate, polyoctalene-adipate, polyethylene-glutarate, polypropylene-glutarate, polybutylene-glutarate, polypentylene-glutarate, polyhexylene-glutarate, polyheptadene-glutarate, polyoctalene-glutarate polyethylene-pimelate, polypropylene-pimelate, polybutylene-pimelate, polypentylene-pimelate, polyhexylene-pimelate, polyheptadene-pimelate, poly(ethoxylated bisphenol A-fumarate), poly(ethoxylated bisphenol A-succinate), poly(ethoxylated bisphenol A-adipate), poly(ethoxylated bisphenol A-glutarate), poly(ethoxylated bisphenol A-terephthalate), poly(ethoxylated bisphenol A-isophthalate), poly(ethoxylated bisphenol A-dodecenylsuccinate), poly(propoxylated bisphenol A-fumarate), poly(propoxylated bisphenol A-succinate), poly(propoxylated bisphenol A-adipate), poly(propoxylated bisphenol A-glutarate), poly(propoxylated bisphenol A-terephthalate), poly(propoxylated bisphenol A-isophthalate), poly(propoxylated bisphenol A-dodecenylsuccinate), SPAR (Dixie Chemicals), BECKOSOL (Reichhold Inc), ARAKOTE (Ciba-Geigy Corporation), HETRON (Ashland Chemical), PARAPLEX (Rohm & Haas), POLYLITE (Reichhold Inc), PLASTHALL (Rohm & Haas), CYGAL (American Cyanamide), ARMCO (Armco Composites), ARPOL (Ashland Chemical), CELANEX (Celanese Eng), RYNITE (DuPont), STYPOL (Freeman Chemical Corporation) and combinations thereof. The resins can also be functionalized, such as carboxylated, sulfonated, or the like, and particularly such as sodio sulfonated, if desired.

The amorphous polyester resin may be a branched resin. As used herein, the terms “branched” or “branching” includes branched resin and/or cross-linked resins. Branching agents for use in forming these branched resins include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid, acid anhydrides thereof, and lower alkyl esters thereof, 1 to about 6 carbon atoms; a multivalent polyol such as sorbitol, 1,2,3,6-hexanetetrol, 1,4-sorbitane, pentaerythritol, dipentaerythritol, tripentaerythritol, sucrose, 1,2,4-butanetriol, 1,2,5-pentatriol, glycerol, 2-methylpropanethiol, 2-methyl-1,2,4-butanetriol, trimethylolethane, trimethylolpropane, 1,3,5-trihydroxymethylbenzene, mixtures thereof, and the like. The branching agent amount selected is, for example, from about 0.1 to about 5 mole percent of the resin.

Linear or branched unsaturated polyesters selected for reactions include both saturated and unsaturated diacids (or anhydrides) and dihydric alcohols (glycols or diols). The resulting unsaturated polyesters are reactive (for example, crosslinkable) on two fronts: (i) unsaturation sites (double bonds) along the polyester chain, and (ii) functional groups such as carboxyl, hydroxy, and the like groups amenable to acid-base reactions. Typical unsaturated polyester resins may be prepared by melt polycondensation or other polymerization processes using diacids and/or anhydrides and diols.

In embodiments, a suitable amorphous resin utilized in a toner of the present disclosure may be a low molecular weight amorphous resin, sometimes referred to, in embodiments, as an oligomer, having a weight average molecular weight (Mw) of from about 500 daltons to about 10,000 daltons, in embodiments from about 1000 daltons to about 5000 daltons, in other embodiments from about 1500 daltons to about 4000 daltons.

The low molecular weight amorphous resin may possess a glass transition temperature (Tg) of from about 60° C. to about 70° C., in embodiments from about 62° C. to about 64° C. These low molecular weight amorphous resins may be referred to, in embodiments, as a high Tg amorphous resin.

The low molecular weight amorphous resin may possess a softening point of from about 105° C. to about 118° C., in embodiments from about 106° C. to about 114° C.

In other embodiments, an amorphous resin utilized in forming a toner of the present disclosure may be a high molecular weight amorphous resin. As used herein, the high molecular weight amorphous polyester resin may have, for example, a number average molecular weight (Mₙ), as measured by gel permeation chromatography (GPC) of, for example, from about 1,000 to about 10,000, in embodiments from about 2,000 to about 9,000, in embodiments from about 3,000 to about 8,000, and in embodiments from about 6,000 to about 7,000. The weight average molecular weight (M_{w}) of the resin is greater than 45,000, for example, from about 45,000 to about 150,000, in embodiments from about 50,000 to about 100,000, in embodiments from about 63,000 to about 94,000, and in embodiments from about 68,000 to about 85,000, as determined by GPC using polystyrene standard. The polydispersity index (PD) is greater than about 3, such as, for example, in embodiments from about 3 to about 20, in embodiments from about 4 to about 10, and in embodiments from about 5 to about 8, as measured by GPC versus standard polystyrene reference resins. The PD index is the ratio of the weight-average molecular weight (M_{w}) to the number-average molecular weight (Mₙ). The low molecular weight amorphous polyester resins may have an acid value of from about 8 to about 20 mg KOH/g, in embodiments from about 9 to about 16 mg KOH/g, and in embodiments from about 11 to about 15 mg KOH/g. The high molecular weight amorphous polyester resins, which are available from a number of sources, can possess various softening points of, for example, from about 30° C. to about 140° C., in embodiments from about 75° C. to about 130° C., in embodiments from about 100° C. to about 125° C., and in embodiments from about 115° C. to about 124° C.

High molecular weight amorphous resins may possess a glass transition temperature of from about 53° C. to about 59° C., in embodiments from about 54.5° C. to about 57° C. These high molecular weight amorphous resins may be referred to, in embodiments, as a low Tg amorphous resin.

In embodiments, a combination of low Tg and high Tg amorphous resins may be used to form a toner of the present disclosure. The ratio of low Tg amorphous resin to high Tg amorphous resin may be from about 0:100 to about 100:0, in embodiments from about 30:70 to about 50:50. In embodiments, the combined amorphous resins may have a melt viscosity of from about 10 to about 1,000,000 Pa*S at about 130° C., in embodiments from about 50 to about 100,000 Pa*S.

The amorphous resin is generally present in the toner composition in various suitable amounts, such as from about 60 to about 90 weight percent, in embodiments from about 50 to about 70 weight percent, of the toner or of the solids.

In embodiments, the toner composition may include at least one crystalline resin. As used herein, “crystalline” refers to a polyester with a three dimensional order. “Semicrystalline resins” as used herein refers to resins with a crystalline percentage of, for example, from about 10 to about 90%, in embodiments from about 12 to about 70%. Further, as used herein, “crystalline polyester resins” and “crystalline resins” encompass both crystalline resins and semicrystalline resins, unless otherwise specified.

In embodiments, the crystalline polyester resin is a saturated crystalline polyester resin or an unsaturated crystalline polyester resin.

For forming a crystalline polyester, suitable organic diols include aliphatic diols having from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, ethylene glycol, combinations thereof, and the like. The aliphatic diol may be, for example, selected in an amount of from about 40 to about 60 mole percent, in embodiments from about 42 to about 55 mole percent, in embodiments from about 45 to about 53 mole percent of the resin.

Examples of organic diacids or diesters selected for the preparation of the crystalline resins include oxalic acid, succinic acid, glutaric acid, adipic acid, suberic acid, azelaic acid, fumaric acid, maleic acid, dodecanedioic acid, sebacic acid, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof, and combinations thereof. The organic diacid may be selected in an amount of, for example, in embodiments from about 40 to about 60 mole percent, in embodiments from about 42 to about 55 mole percent, in embodiments from about 45 to about 53 mole percent.

Examples of polyester-based crystalline resins include, but are not limited to, poly(ethylene-adipate), polypropylene-adipate), poly(butylene-adipate), poly(pentylene-adipate), poly(hexylene-adipate), poly(octylene-adipate), poly(ethylene-succinate), polypropylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), alkali copoly(5-sulfoisophthaloyl)-copoly(ethylene-adipate), poly(decylene-sebacate), poly(decylene-decanoate), poly-(ethylene-decanoate), poly-(ethylene-dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), and combinations thereof. The crystalline resin may be present, for example, in an amount of from about 5 to about 50 percent by weight of the toner components, in embodiments from about 10 to about 35 percent by weight of the toner components.

The crystalline polyester resins, which are available from a number of sources, may possess various melting points of, for example, from about 30° C. to about 120° C., in embodiments from about 50° C. to about 90° C. The crystalline resins may have, for example, a number average molecular weight (Mₙ), as measured by gel permeation chromatography (GPC) of, for example, from about 1,000 to about 50,000, in embodiments from about 2,000 to about 25,000, in embodiments from about 3,000 to about 15,000, and in embodiments from about 6,000 to about 12,000. The weight average molecular weight (M_{w}) of the resin is 50,000 or less, for example, from about 2,000 to about 50,000, in embodiments from about 3,000 to about 40,000, in embodiments from about 10,000 to about 30,000 and in embodiments from about 21,000 to about 24,000, as determined by GPC using polystyrene standards. The molecular weight distribution (M_{w}/Mₙ) of the crystalline resin is, for example, from about 2 to about 6, in embodiments from about 3 to about 4. The crystalline polyester resins may have an acid value of about 2 to about 20 mg KOH/g, in embodiments from about 5 to about 16 mg KOH/g, and in embodiments from about 8 to about 15 mg KOH/g. The acid value (or neutralization number) is the mass of potassium hydroxide (KOH) in milligrams that is required to neutralize one gram of the crystalline polyester resin.

Suitable crystalline polyester resins include those disclosed in U.S. Pat. No. 7,329,476 and U.S. Patent Application Publication Nos. 2006/0216626, 2008/0107990, 2008/0236446 and 2009/0047593, each of which is hereby incorporated by reference in their entirety. In embodiments, a suitable crystalline resin may include a resin composed of ethylene glycol or nonanediol and a mixture of dodecanedioic acid and fumaric acid co-monomers with the following formula (II):

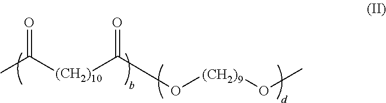

wherein b is from about 5 to about 2000 and d is from about 5 to about 2000.

If semicrystalline polyester resins are employed herein, the semicrystalline resin may include poly(3-methyl-1-butene), poly(hexamethylene carbonate), poly(ethylene-p-carboxy phenoxy-butyrate), poly(ethylene-vinyl acetate), poly(docosyl acrylate), poly(dodecyl acrylate), poly(octadecyl acrylate), poly(octadecyl methacrylate), poly(behenylpolyethoxyethyl methacrylate), poly(ethylene adipate), poly(decamethylene adipate), poly(decamethylene azelate), poly(hexamethylene oxalate), poly(decamethylene oxalate), poly(ethylene oxide), poly(propylene oxide), poly(butadiene oxide), poly(decamethylene oxide), poly(decamethylene sulfide), poly(decamethylene disulfide), poly(ethylene sebacate), poly(decamethylene sebacate), poly(ethylene suberate), poly(decamethylene succinate), poly(eicosamethylene malonate), poly(ethylene-p-carboxy phenoxy-undecanoate), poly(ethylene dithionesophthalate), poly(methyl ethylene terephthalate), poly(ethylene-p-carboxy phenoxy-valerate), poly(hexamethylene-4,4′-oxydibenzoate), poly(10-hydroxy capric acid), poly(isophthalaldehyde), poly(octamethylene dodecanedioate), poly(dimethyl siloxane), poly(dipropyl siloxane), poly(tetramethylene phenylene diacetate), poly(tetramethylene trithiodicarboxylate), poly(trimethylene dodecane dioate), poly(m-xylene), poly(p-xylylene pimelamide), and combinations thereof.

A crystalline polyester resin in a toner particle of the present disclosure may be present in an amount of from about 1 to about 15 percent by weight, in embodiments from about 5 to about 10 percent by weight, and in embodiments from about 6 to about 8 percent by weight, of the toner particles (that is, toner particles exclusive of external additives and water).

As noted above, in embodiments a toner of the present disclosure may also include at least one high molecular weight branched or cross-linked amorphous polyester resin. This high molecular weight resin may include, in embodiments, for example, a branched amorphous resin or amorphous polyester, a cross-linked amorphous resin or amorphous polyester, or mixtures thereof, or a non-cross-linked amorphous polyester resin that has been subjected to cross-linking. In accordance with the present disclosure, from about 1% by weight to about 100% by weight of the high molecular weight amorphous polyester resin may be branched or cross-linked, in embodiments from about 2% by weight to about 50% by weight of the higher molecular weight amorphous polyester resin may be branched or cross-linked.

In embodiments, toner particles of the present disclosure may have a core including from about 10% by weight to about 90% by weight of a low molecular weight, high Tg, amorphous resin, in embodiments from about 20% by weight to about 80% by weight of a low molecular weight, high Tg, amorphous resin, in combination with from about 10% by weight to about 90% by weight of a high molecular weight, low Tg, amorphous resin, in embodiments from about 20% by weight to about 80% by weight of a high molecular weight, low Tg, amorphous resin.

Such toner particles may also include a shell including from about 20% by weight to about 45% by weight of a low molecular weight, high Tg, amorphous resin, in embodiments from about 28% by weight to about 34% by weight of an amorphous resin which, in embodiments, may be a low molecular weight, high Tg, resin, optionally in combination with a high molecular weight, low Tg, amorphous resin.

As noted above, in embodiments, the resin particles may be formed by emulsion aggregation methods. Utilizing such methods, the resin may be present in a resin emulsion, which may then be combined with other components and additives to form a toner of the present disclosure.

### Toner

The resin described above may be utilized to form toner compositions. Such toner compositions may include optional colorants, waxes, and other additives. Toners may be formed utilizing any method within the purview of those skilled in the art.

### Surfactants

In embodiments, colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be utilized. The surfactants may be selected from ionic surfactants and nonionic surfactants. Anionic surfactants and cationic surfactants are encompassed by the term “ionic surfactants.” In embodiments, the surfactant may be utilized so that it is present in an amount of from about 0.01% to about 5% by weight of the toner composition, for example from about 0.75% to about 4% by weight of the toner composition, in embodiments from about 1% to about 3% by weight of the toner composition.

Where utilized, a resin emulsion may include one, two, or more surfactants. In embodiments, the surfactant may be added as a solid or as a solution with a concentration of from about 5% to about 100% (pure surfactant) by weight, in embodiments, from about 10% to about 95% by weight. In embodiments, the surfactant may be utilized so that it is present in an amount of from about 0.01% to about 20% by weight of the resin, in embodiments, from about 0.1% to about 16% by weight of the resin, in other embodiments, from about 1% to about 14% by weight of the resin.

Examples of nonionic surfactants that can be utilized include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenc as IGEPAL CA-210™, IGEPAL CA-520™, IGEPAL CA-520™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC PE/F, in embodiments SYNPERONIC PE/F 108.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN RK™, and/or NEOGEN SC™ obtained from Daiichi Kogyo Seiyaku, combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

### Colorants

As the optional colorant to be added, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and optional colorant in forming toner particles. When included, the wax may be present in an amount of, for example, from about 1 weight percent to about 25 weight percent of the toner particles, in embodiments from about 5 weight percent to about 20 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Ferromagnetic Particles

In embodiments, it may be desirable to incorporate magnetic metal oxide particles into the toner formulation to thus form an MICR toner.

The magnetic metal oxide may be, in embodiments, MₓN_{y}O_{z}, wherein M is Mn, Co, Ni, Mg, Cu, Zn, Ba, Sr, combinations thereof, and the like; N is Fe, Co, Ni, combinations thereof, and the like; x is from 0.1 to 20, y is from 1 to 20, and z is from 1 to 40.

The magnetic metal oxide particles may, in embodiments, be nanoparticles of a size of from about 1 nm to about 1,000 nm in diameter, in embodiments from about 2 nm to about 200 nm in diameter, in embodiments from about 5 nm to about 100 nm in diameter. Magnetic metal oxide particles have a relatively low shape anisotropy, e.g., of about 1, unlike conventional ferromagnetic particles, such as iron oxide, which have an acicular crystal shape (e.g., high anisotropy due to the elongated shape).

Magnetic metal oxide particles according to the present disclosure also have a spherical morphology. Circularity of the magnetic metal oxide nanoparticles may be determined using the following equation:

$$Circularity = \frac{Circle Circumference}{Perimeter of Particle} = \frac{2 \sqrt{π {A}_{p}}}{{P}_{p}} \\ {A}_{p} = Area of the Particle \\ {P}_{p} = Perimeter of the Particle \qquad ( III )$$

The magnetic metal oxide nanoparticles utilized in accordance with the present disclosure thus possess a circularity of from about 0.5 to about 1, in embodiments from about 0.65 to about 1, in embodiments from about 0.75 to about 1.

The magnetic metal oxide nanoparticles utilized in accordance with the present disclosure show remanence and retentivity that is at least three times higher compared to that observed with conventional magnetites, in embodiments from about 1 to about 30 times higher, in embodiments from about 2 to about 20 times higher, compared to that observed with conventional magnetites. Thus, much lower loadings of these magnetic metal oxide particles are required in toners, improving the ability to produce these toners using an emulsion aggregation process.

Barium iron oxide particles may be present in a toner of the present disclosure in an amount of from about 2% by weight to about 50% by weight of the toner particles, in embodiments from about 3% by weight to about 30% by weight of the toner particles, in embodiments from about 5% by weight to about 20% by weight of the toner particles.

The barium iron oxide particles according to the present disclosure may be formed as a dispersion, which may then be used to form EA MICR toners. The dispersion may be formed by mixing the barium iron oxide particles with a dispersant and water. In embodiments, a functional polyether may be utilized as a dispersant in the preparation of the barium iron oxide nanoparticles. The functional polyether may have the following structure:

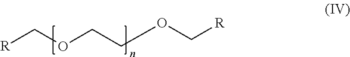

wherein R can be —COOH, —OH, —NH₂, and/or —SH, and n is from about 1 to about 1000, in embodiments from about 2 to about 500.

In embodiments, the functional polyether may be poly(ethyleneglycol)bis(carboxymethyl)ether having the following structure:

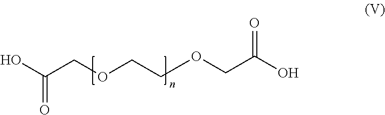

wherein n may be from about 1 to 1000. In other embodiments, instead of COOH, the functional polyether may possess groups such as OH, NH₂, combinations thereof, and the like.

A dispersion including a magnetic metal oxide, in embodiments barium iron oxide, a dispersant, and water may possess the magnetic metal oxide in amounts from about 1% to about 60% by weight of the dispersion, in embodiments from about 5 to about 50% by weight of the dispersion, the dispersant in amounts from about 1% to about 50% by weight of the dispersion, in embodiments from about 2 to about 30% by weight of the dispersion, with the balance being water.

The mixture of the barium iron oxide, the dispersant, and water may be milled using a dispersion mill to obtain particles having a desired size. Suitable dispersion mills include, but are not limited to, a ball mill, an attritor mill, a vibratory mill, and media mills such as a sand mill and a bead mill. The milling time can vary widely and may depend upon mechanical properties of the mixture and processing conditions. Processing time may be from about 0.5 hours to about 100 hours, in embodiments, from about 2 hours to about 50 hours. Dispersion of the barium iron oxide particles stabilizes the particles and provides easier incorporation into the toner as discussed in more detail below.

### Toner Preparation

The toner particles may be prepared by any method within the purview of one skilled in the art. Although embodiments relating to toner particle production are described below with respect to emulsion aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion aggregation processes, such as a process that includes aggregating a mixture of an optional colorant, an optional wax and any other desired or required additives, and emulsions including the resins described above and the barium iron oxide particles, optionally in a dispersion, and optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The magnetic metal oxide nanoparticle dispersion, in embodiments barium iron oxide, is contacted with other toner components under homogenization, which may be accomplished by mixing at a rate from 1000 to about 10000 revolutions per minute (rpm), in embodiments from about 600 to about 6,000 revolutions per minute (rpm). Homogenization may be accomplished by any suitable means, including, for example, an IKA ULTRA TURRAX T50 probe homogenizer. The pH of the resulting mixture may be adjusted by addition of an acid such as, for example, acetic acid, nitric acid or the like. In embodiments, the pH of the mixture may be adjusted to from about 1 to about 6, in embodiment from about 2 to about 5.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in embodiments from about 0.2% to about 5% by weight, in other embodiments from about 0.5% to about 5% by weight, of the resin in the mixture. This provides a sufficient amount of agent for aggregation.

In order to control aggregation and subsequent coalescence of the particles, in embodiments the aggregating agent may be metered into the mixture over time. For example, the agent may be metered into the mixture over a period of from about 5 to about 240 minutes, in embodiments from about 30 to about 200 minutes. The addition of the agent may also be done while the mixture is maintained under stirred conditions, in embodiments from about 50 revolutions per minute (rpm) to about 1,000 rpm, in other embodiments from about 100 rpm to about 500 rpm, and at a temperature that is below the glass transition temperature of the resin as discussed above, in embodiments from about 30° C. to about 90° C., in embodiments from about 35° C. to about 70° C.

In other embodiments, the emulsion aggregation process may occur upon addition of acid without an aggregating agent. The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in embodiments from about hour 1 to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value of from about 6 to about 14, and in embodiments from about 7 to about 12. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help freeze, i.e., stop, the growth of the toner particles.

### Shell Resin

In embodiments, after aggregation, but prior to coalescence, a shell may be applied to the aggregated particles. Resins which may be utilized to form the shell include, but are not limited to, the amorphous resins described above. In embodiments, an amorphous resin which may be used to form a shell in accordance with the present disclosure may include an amorphous polyester of formula I above.

In some embodiments, the amorphous resin utilized to form the shell may be crosslinked. For example, crosslinking may be achieved by combining an amorphous resin with a crosslinker, sometimes referred to herein, in embodiments, as an initiator. Examples of suitable crosslinkers include, but are not limited to, for example free radical or thermal initiators such as organic peroxides and azo compounds described above as suitable for forming a gel. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di(2-ethyl hexanoyl peroxy) hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di(benzoyl peroxy)hexane, oo-t-butyl o-(2-ethyl hexyl)mono peroxy carbonate, and oo-t-amyl o-(2-ethyl hexyl)mono peroxy carbonate, alkyl peroxides such as, for example, dicumyl peroxide, 2,5-dimethyl 2,5-di(t-butyl peroxy)hexane, t-butyl cumyl peroxide, α-α-bis(t-butyl peroxy)diisopropyl benzene, di-t-butyl peroxide and 2,5-dimethyl 2,5di(t-butyl peroxy) hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di(t-butyl peroxy) valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2-di(t-butyl peroxy) butane, ethyl 3,3-di(t-butyl peroxy) butyrate and ethyl 3,3-di(t-amyl peroxy) butyrate, and combinations thereof. Examples of suitable azo compounds include 2,2,′-azobis(2,4-dimethylpentane nitrile), azobis-isobutyronitrile, 2,2′-azobis(isobutyronitrile), 2,2′-azobis(2,4-dimethyl valeronitrile), 2,2′-azobis(methyl butyronitrile), 1,1′-azobis(cyano cyclohexane), other similar known compounds, and combinations thereof.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 30° C. to about 95° C., for a period of time of from about 1 minute to about 10 hours, in embodiments from about 5 minutes to about 5 hours, to form a crosslinked polyester resin or polyester gel suitable for use as a shell.

Where utilized, the crosslinker may be present in an amount of from about 0.001% by weight to about 5% by weight of the resin, in embodiments from about 0.01% by weight to about 1% by weight of the resin. The amount of CCA may be reduced in the presence of crosslinker or initiator.

A single polyester resin may be utilized as the shell or, in embodiments, a first polyester resin may be combined with other resins to form a shell. Multiple resins may be utilized in any suitable amounts. In embodiments, a first amorphous polyester resin, for example a high Tg amorphous resin described above, may be present in an amount of from about 0 percent by weight to about 100 percent by weight of the total shell resin, in embodiments from about 20 percent by weight to about 80 percent by weight of the total shell resin. Thus, in embodiments, a second resin, in embodiments a low Tg amorphous resin, may be present in the shell resin in an amount of from about 0 percent by weight to about 100 percent by weight of the total shell resin, in embodiments from about 20 percent by weight to about 80 percent by weight of the shell resin.

### Coalescence

Following aggregation to the desired particle size and application of any shell resin as described above, the particles may then be coalesced to the desired final shape, the coalescence being achieved by, for example, heating the mixture to a suitable temperature. This temperature may, in embodiments, be from about 0° C. to about 50° C. higher than the onset melting point of the crystalline polyester resin utilized in the core, in other embodiments from about 5° C. to about 30° C. higher than the onset melting point of the crystalline polyester resin utilized in the core. Higher or lower temperatures may be used, it being understood that the temperature is a function of the resins used.

Coalescence may occur at a pH of about 3 to about 9, in embodiments from about 4 to about 8, in embodiments from about 5 to about 7.

Coalescence may also be carried out with stirring, for example at a speed of from about 50 rpm to about 1,000 rpm, in embodiments from about 100 rpm to about 600 rpm. Coalescence may be accomplished over a period of from about 1 minute to about 24 hours, in embodiments from about 5 minutes to about 10 hours.

After coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

While the above disclosure has described polyester based EA MICR toner compositions in detail, the barium iron oxide particles of the present disclosure may be utilized with any toner within the purview of those skilled in the art. Thus, in addition to the emulsion aggregation toners, as previously described, in embodiments the barium iron oxide particles described herein may be utilized with conventional toners produced by melt-mixing resins, optionally with colorants, and optionally with waxes, forming agglomerated particles, and grinding or similarly treating the agglomerated particles to form toner particles. In other embodiments, the barium iron oxide particles described herein may be utilized with toners produced by chemical synthesis methods, including toners produced in suspensions, by chemical milling, combinations thereof, and the like.

### Additives

In embodiments, the toner particles may also contain other optional additives, as desired or required. For example, there can be blended with the toner particles external additive particles including charge control agents (CCAs), flow aid additives, combinations thereof, and the like, which additives may be present on the surface of the toner particles. Examples of these additives include metal oxides such as titanium oxide, silicon oxide, tin oxide, mixtures thereof, and the like; colloidal and amorphous silicas, such as AEROSIL®, metal salts and metal salts of fatty acids inclusive of zinc stearate, aluminum oxides, cerium oxides, and mixtures thereof. Each of these external additives may be present in an amount of from about 0.1 percent by weight to about 5 percent by weight of the toner, in embodiments of from about 0.25 percent by weight to about 3 percent by weight of the toner. Suitable additives include those disclosed in U.S. Pat. Nos. 3,590,000, 6,214,507, and 7,452,646 the disclosures of each of which are hereby incorporated by reference in their entirety. Again, these additives may be applied simultaneously with the shell resin described above or after application of the shell resin.

In embodiments, toners of the present disclosure may be utilized as ultra low melt (ULM) toners. The addition of the barium iron oxide particles does not adversely affect the morphology of the toner particles. In embodiments, the dry toner particles of the present disclosure may, exclusive of external surface additives, have the following characteristics:

(1) Volume average diameter (also referred to as “volume average particle diameter”) of from about 3 to about 25 μm, in embodiments from about 4 to about 15 in other embodiments from about 5 to about 12 μm.

(2) Number Average Geometric Size Distribution (GSDn) and/or Volume Average Geometric Size Distribution (GSDv) of from about 1.05 to about 1.55, in embodiments from about 1.1 to about 1.45.

(3) Circularity of from about 0.93 to about 1, in embodiments from about 0.93 to about 0.99 (measured with, for example, a SYSMEX FPIA 2100 analyzer).

The characteristics of the toner particles may be determined by any suitable technique and apparatus. Volume average particle diameter D₅₀ᵥ, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

Toners produced in accordance with the present disclosure may possess excellent charging characteristics when exposed to extreme relative humidity (RH) conditions. The low-humidity zone (C zone) may be about 10° C./15% RH, while the high humidity zone (A zone) may be about 28° C./85% RH. Toners of the present disclosure may possess A zone charging of from about −3 μC/g to about −60 μC/g, in embodiments from about −4 μC/g to about −50 μC/g, a parent toner charge per mass ratio (Q/M) of from about −3 μC/g to about −60 μC/g, in embodiments from about −4 μC/g to about −50 μC/g, and a final triboelectric charge of from −4 μC/g to about −50 μC/g, in embodiments from about −5 μC/g to about −40 μC/g.

In accordance with the present disclosure, the charging of the toner particles may be enhanced, so less surface additives may be required, and the final toner charging may thus be higher to meet machine charging requirements.

### Developers

The toner particles thus obtained may be formulated into a developer composition. The toner particles may be mixed with carrier particles to achieve a two-component developer composition. The toner concentration in the developer may be from about 1% to about 25% by weight of the total weight of the developer, in embodiments from about 2% to about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrophotographic processes, including those disclosed in U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with an electrophotographic device including a charging component, an imaging component, a photoconductive component, a developing component, a transfer component, and a fusing component. In embodiments, the development component may include a developer prepared by mixing a carrier with a toner composition described herein. The electrophotographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

In embodiments where the toner resin is crosslinkable, such crosslinking may be accomplished in any suitable manner. For example, the toner resin may be crosslinked during fusing of the toner to the substrate where the toner resin is crosslinkable at the fusing temperature. Crosslinking also may be affected by heating the fused image to a temperature at which the toner resin will be crosslinked, for example in a post-fusing operation. In embodiments, crosslinking may be effected at temperatures of from about 160° C. or less, in embodiments from about 70° C. to about 160° C., in other embodiments from about 80° C. to about 140° C.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

Preparation of barium iron oxide (BaFe₁₂O₁₉) nano-particles in a dispersion.

About 20 grams of BaFe₁₂O₁₉ nano-particles, about 4 grams of poly(ethyleneglycol)bis(carboxymethyl)ether from Sigma Aldrich, and about 25 grams of deionized water were added to a 250 milliliter (ml) plastic container. The mixture was ball-milled using stainless steel shots overnight for a period of from about 12 hours to about 24 hours. After screening off the stainless steel shots, the remaining dispersion was collected and the solids content was removed. The dispersion had a solids content of about 10.4%.

### Example 2

Preparation of EA toner containing 15% by weight of the BaFe₁₂O₁₉ nano-particles from Example 1.

A magnetic ink character recognition toner was prepared at a 2 liter bench scale. A toner slurry was utilized which included two amorphous polyester resin emulsions (at a ratio of about 50:50). One emulsion included about 53.51 grams of a high molecular weight resin including alkoxylated bisphenol A with terephthalic acid, trimellitic acid, and dodecenylsuccinic acid co-monomers (concentration of the resin was about 38.5% by weight of the emulsion), and the other emulsion included about 56.79 grams of a low molecular weight resin including an alkoxylated bisphenol A with terephthalic acid, fumaric acid, and dodecenylsuccinic acid co-monomers (concentration of the resin was about 37% by weight of the emulsion). Also added thereto was about 19.48 grams of a crystalline resin emulsion of the following formula:

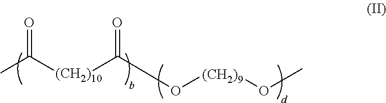

wherein b was from about 5 to about 2000 and d was from about 5 to about 2000 (concentration of the resin was about 35.6% by weight of the emulsion). The components were mixed and then pH was adjusted to about 3. About 144.23 grams of the BaFe₁₂O₁₉ dispersion of Example 1 (concentration of the particles was about 10.4% by weight of the dispersion) was added under homogenization. The pH was increased to about 4.2 due to the introduction of the BaFe₁₂O₁₉ dispersion.

About 49.87 grams of an aluminum sulfate Al₂(SO₄)₃ aqueous solution, having a concentration of about 1% by weight, was added in as a flocculent under homogenization at a speed of from about 3000 revolutions per minute (rpm) to about 4000 rpm. The particle size was closely monitored with a Coulter Counter until the core particles had an average particle diameter of about 5.65 microns and a Volume Average Geometric Size Distribution (GSDv) of about 1.19. At this point, a shell including the same amorphous emulsions (ratio 50:50) as in the core was added to achieve the final targeted particle size of about 6.55 microns. (One emulsion included about 36.36 grams of the high molecular weight resin and the other emulsion included about 38.59 grams of the low molecular weight resin.) The particles had a GSDv of about 1.18 and a Number Average Geometric Size Distribution (GSDn) of about 1.19.

The pH of the slurry was adjusted to about 7.9 using a sodium hydroxide (NaOH) aqueous solution having a concentration of about 4% by weight. About 3.85 grams of an aqueous solution of ethylene diamine tetraacetic acid (EDTA) (commercially available as VERSENE-100 from the Dow Chemical Company) at a concentration of about 39% by weight was added to the slurry to freeze, i.e., stop, the aggregation of the toner particles.

The process proceeded with the reactor temperature (Tr) increased to about 85° C. Once the Tr reached 85° C., the pH of the toner slurry was reduced to about 5.97 to begin the coalescence process. After the toner coalesced to form particles, the toner was quenched.

The toner had an average particle diameter of about 8.59 microns, a GSDv of about 1.28, and a GSDn of about 1.31. The toner was substantially round in shape and was separated through a 25 micrometer sieve, then filtered, followed by washing and freeze drying.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An emulsion aggregation toner comprising:
at least one resin in combination with one or more optional ingredients selected from the group consisting of colorants, waxes, and combinations thereof; and
a plurality of magnetic metal oxide nanoparticles,
wherein the magnetic metal oxide is of the formula MₓN_{y}O_{z}, wherein M is selected from the group consisting of Mn, Co, Ni, Mg, Cu, Zn, Ba, Sr, and combinations thereof, N is selected from the group consisting of Fe, Co, Ni, and combinations thereof, x is from 0.1 to 20, y is from 1 to 20, and z is from 1 to 40.

2. The toner of claim 1, wherein the plurality of magnetic metal oxide nanoparticles have a diameter of from about 1 nm to about 1000 nm.

3. The toner of claim 1, wherein the plurality of magnetic metal oxide nanoparticles possess a circularity of from about 0.65 to about 1.

4. The toner of claim 1, wherein the plurality of magnetic metal oxide nanoparticles have a diameter of from about 2 nm to about 200 nm.

5. The toner of claim 1, wherein plurality of magnetic metal oxide nanoparticles are present in an amount from about 2% by weight to about 50% by weight of the toner particles.

6. The toner of claim 1, wherein the at least one resin comprises at least one amorphous resin in combination with at least one crystalline resin.

7. The toner of claim 5, wherein the at least one amorphous resin comprises an alkoxylated bisphenol A fumarate/terephthalate based polyester or copolyester resin, and wherein the at least one crystalline resin comprises 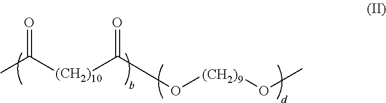
wherein b is from about 5 to about 2000 and d is from about 5 to about 2000.

8. A process comprising:
contacting at least one resin emulsion and a plurality of magnetic metal oxide nanoparticles in a mixture;
aggregating the mixture at a pH from about 1 to about 6 to form particles;
adjusting the pH of the mixture to from about 6 to about 14 to stop growth of the particles;
coalescing the particles at a pH from about 3 to about 9 to form toner particles; and
recovering the toner particles,
wherein the magnetic metal oxide is of the formula MₓN_{y}O_{z}, wherein M is selected from the group consisting of Mn, Co, Ni, Mg, Cu, Zn, Ba, Sr, and combinations thereof, N is selected from the group consisting of Fe, Co, Ni, and combinations thereof, x is from 0.1 to 20, y is from 1 to 20, and z is from 1 to 40.

9. The process of claim 8, wherein plurality of magnetic metal oxide nanoparticles have a diameter of from about 1 nm to about 1000 nm, and wherein the plurality of magnetic metal oxide nanoparticles possess a circularity of from about 0.65 to about 1.

10. The process of claim 8, wherein the magnetic metal oxide dispersion is contacted with the resin latex and other toner components under homogenization at a rate of from about 1000 rpm to about 10000 rpm.

11. The process of claim 8, wherein the plurality of magnetic metal oxide nanoparticles are in a dispersion including a dispersant and water.

12. The process of claim 11, wherein the dispersant is a polyether of the following formula 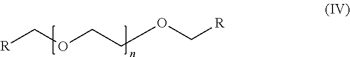
wherein R is selected from the group consisting of —COOH, —OH, —NH2, —SH, and combinations thereof, and n is from about 1 to about 1000.

13. The process of claim 11, wherein the dispersion is formed by milling the magnetic metal oxide, the dispersant, and the water.

14. A process comprising:
contacting at least one resin emulsion and a plurality of magnetic metal oxide nanoparticles in a mixture;
aggregating the mixture at a pH from about 1 to about 6 to form particles;
adjusting the pH of the mixture to from about 6 to about 14 to stop growth of the particles;
coalescing the particles at a pH from about 3 to about 9 to form toner particles; and
recovering the toner particles,
wherein the magnetic metal oxide is of the formula MₓN_{y}O_{z}, wherein M is selected from the group consisting of Mn Co, Ni, Mg Cu, Zn, Ba, Sr, and combinations thereof, N is selected from the group consisting of Fe, Co, Ni, and combinations thereof, x is from 0.1 to 20, y is from 1 to 20, and z is from 1 to 40, and wherein the plurality of magnetic metal oxide nanoparticles possess a circularity of from about 0.65 to about 1.

15. The process of claim 14, wherein the plurality of magnetic metal oxide nanoparticles have a diameter of from about 1 nm to about 1000 nm.

16. The process of claim 14, wherein the plurality of magnetic metal oxide particles are in a dispersion with a dispersant and water.

17. The process of claim 16, wherein the dispersant is a polyether of the following formula 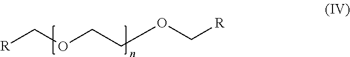
wherein R is selected from the group consisting of —COOH, —OH, —NH₂, —SH, and combinations thereof, and n is from about 1 to about 1000.

18. The process of claim 14, wherein the magnetic metal oxide dispersion is contacted with the resin latex and other toner components under homogenization at a rate from about 1000 rpm to about 10000 rpm.

19. The process of claim 14, wherein the at least one resin comprises at least one amorphous resin in combination with at least one crystalline resin.

20. The process of claim 19, wherein the at least one amorphous resin comprises an alkoxylated bisphenol A fumarate/terephthalate based polyester or copolyester resin, and wherein the at least one crystalline resin comprises 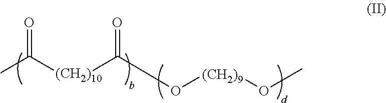
wherein b is from about 5 to about 2000 and d is from about 5 to about 2000.
